(19) United States
(12) Patent Application Publication
(10) Pub. No.: US 2026/0123632 A1
(43) Pub. Date: May 7, 2026

(54) BIOCIDAL COMPOSITIONS AND METHODS OF MAKING THE SAME

(71) Applicant: WIAB WATER INNOVATION AB, Malmo (SE)

(72) Inventor: Geir Hermod Almås, Snarøya (NO)

(21) Appl. No.: 19/425,077

(22) Filed: Dec. 18, 2025

Related U.S. Application Data
(63) Continuation of application No. 17/837,689, filed on Jun. 10, 2022.
(60) Provisional application No. 63/209,704, filed on Jun. 11, 2021.

(51) Int. Cl. A01N 59/00; A01N 25/04; A01P 1/00

(52) U.S. Cl. CPC A01N 59/00; A01N 25/04; A01P 1/00

(57) ABSTRACT

The invention provides biocidal compositions comprising aqueous solutions of hypochlorite buffered with an organic acid and a base and in which chlorate, as a percentage of all active species of chlorine present, is less than a threshold value such as 5.4% for at least six months after the composition is made.

### CROSS-REFERENCE TO RELATED APPLICATIONS

This application claims priority to, and the benefit of, U.S. Provisional Application No. 63/209,704, filed on Jun. 11, 2021, the content of which is incorporated by reference herein in its entirety.

### TECHNICAL FIELD

The disclosure relates to biocidal products.

### BACKGROUND

The World Health Organization (WHO) has identified twelve bacteria that pose a significant threat to human health due to antibiotic resistance. Those infectious agents include Pseudomonas aeruginosa, the Enterobacteriaceae, Acinetobacter baumannii, Enterococcus faecium, Staphylococcus aureus, Helicobacter pylori, several species of Campylobacter, the Salmonellae, Neisseria gonorrhoeae, Streptococcus pneumoniae, Haemophilus influenzae, and several species of Shigella. Some health experts view antibiotic resistance as a greater threat to human health than cancer. Due to antibiotic resistance, medical procedures such as organ transplantation, caesarean sections, joint replacements, and chemotherapy may be deemed too dangerous to perform. Globally, about 700,000 people die each year due to drug-resistant infections and it has been estimated that such infections may kill ten million people per year by 2050.

Unfortunately, bacteria are not the only infectious agent that pose a significant threat to human health. Viruses are highly infections biomolecular structures that hijack the machinery of living cells to replicate themselves. It is well understood that not only can viruses spread readily and rapidly, but also that some viral infections, when not fatal, can be severely painful with long-term health consequences.

Bacteria and viruses are not the only significant health threats that can be potentially encountered in life in the world. For example, prions are a particularly insidious infectious agent. A prion is a misfolded unhealthy variant of a naturally-occurring protein. When a healthy protein encounters a prion, the misfolded prion can cause the healthy protein to refold into the unhealthy shape. Each misfolded protein can then trigger other proteins to take the misfolded shape. When the affected protein is an important protein in neurons in the brain, the runaway reaction of one misfolded prion protein causing another protein to mis-fold can leave holes throughout the cerebral cortex causing it to appear like a sponge. Because prion diseases can be transmitted from an affected subject to a healthy subject, some of those diseases are referred to as transmissible spongiform encephalopathies.

Some compositions have been proposed to sterilize surfaces and rid them of some infectious agents. For example, U.S. Patent Publication 2008/0008621 to Ikeda reports solutions of hypochlorous acid and acetic acid for use as a less-corrosive sterilizing agent for metal surfaces. U.S. Pat. No. 2,438,781 to Kamlet reports alkali-metal hypochlorite solutions stabilized by the addition of benzylsulfinamide variants for cleaning surfaces. Wang, 2007, J Burns Wounds 6:65-79 reports on hypochlorous acid as a potential wound care agent. Giardino, 2014, Brazilian Dental J 25 (4): 289-294 reports on hypochlorite as an antibacterial. However, those Ikeda, Kamlet, Wang, and Giardino references, all incorporated by reference herein, fail to adequately address the ionic and gaseous species such as chlorate and chlorine gas that may develop in such compositions.

### SUMMARY

The invention provides biocidal compositions made with ingredients and methods that provide strict control over atomic and molecular species in the compositions. In particular, methods have been developed to use hypochlorous acid or sodium hypochlorite while avoiding the presence of more than de minimus amounts of chlorate. To avoid unwanted chlorine species, aqueous solutions of hypochlorite are buffered with an organic acid and a base while being kept cold and air-free. Unwanted ionic or gaseous species are avoided through control of pH, air exposure, ingredients, and temperature throughout production, transportation, and storage. Importantly, it has been found that hypochlorite solutions can be provided in which chlorate, as a percentage of all active species of chlorine present, is less than a threshold value such as 5.4%.

Important to the control of chlorate and unwanted gases, ingredients are selected to limit what is present and to buffer pH of the compositions (e.g., preferably to a pH between about 4 and 5). Also, temperature is controlled throughout the process and preferably for substantially all of production and distribution, temperature is kept beneath about 25 degrees C., e.g., materials are preferably kept at about 5 degrees C. However, it is understood that occasional spikes in temperature of a few hours over six month or a year or years of a life of a product does not lead to development of chlorate above the threshold percent. Further, compositions of the invention are preferably made, stored, transferred between containers, and transported in substantially air-free conditions. Anaerobic practices can be used which may involve, for example, suffusing the headspace over ingredients and compositions of the invention with an inert gas such as nitrogen or argon. Additionally or alternatively ambient or atmospheric gases can be purged from headspace of mixing and storage containers. By disallowing aqueous solutions of the invention to contact and come into equilibrium with common atmospheric air, compositions of the invention do not develop significant dissolved gases such as oxygen or carbon oxides which would shift equilibria of the intended ingredients which may otherwise lead to evolution of excess chlorine gas.

Compositions of the invention are potent disinfectants and can inactivate a variety of infectious agents including bacteria, viruses, and even prions. Compositions of the invention have been made and tested and data presented herein show that chlorate is maintained beneath a threshold percentage of active chlorine species for over 6 months and even for a year or longer when conditions or methods of the disclosure are adhered to.

Aspects of the invention provide a composition that includes an aqueous solvent, an organic acid in the solvent, and chlorine in the solvent, in which chlorate is maintained below a threshold percentage of active species of the chlorine. Preferably the composition has been produced, distributed, and stored substantially without exposure to air and the composition does contain dissolved gases in proportion the partial pressures of those gases in air. The composition may include substantially zero dissolved oxygen or nitrogen (e.g., as a consequence of being air-free and of having been made and stored in air-free conditions). Chlorate remains below the threshold percentage for at least six months after the composition is produced. In preferred embodiments, the composition is held at, and has been since being produced held at, a temperature at or beneath about 25 degrees C., preferably at about 6 degrees C.

The organic acid may be acetic acid. The composition may include a base that, with the organic acid, buffers the composition to a pH within a range between 4.0 and 5.0. In certain embodiments, the organic acid is acetic acid, and the chlorine is introduced as sodium hypochlorite or hypochlorous acid, and the composition is kept beneath about 25 degrees and not exposed to air for substantially all time from production to use.

The composition has a pH kept within a preferred range. For example, the composition may include a strong base such as sodium hydroxide (e.g., to form a buffer with the organic acid). Preferably, the composition is buffered to a pH between about 4 and 5, e.g., buffered to a pH of about 4.4.

The composition may include a viscosity enhancing agent. Enhanced viscosity can make the composition safer for use by consumers, because more viscous mixtures will pour out more slowly than simple aqueous solutions. The viscosity enhancing agent may be any such as poly acrylic acid, polyethylene glycol, poly(acrylic acid)-acrylamidoalkylpropane sulfonic acid co-polymer, phosphino polycarboxylic acid, and poly(acrylic acid)-acrylamidoalkylpropane or sulfonic acid-sulfonated styrene terpolymers.

The chlorine may be obtained and initially provided as sodium hypochlorite (NaOCl) or for example as Mg(OCl)₂ or Ca(OCl)₂. The chlorine may be initially mixed into the aqueous solution in an amount between about 100 and 1,000 ppm (e.g., certain preferred embodiments start with 200 ppm or 450 ppm sodium hypochlorite). In certain embodiments, the organic acid is present between about 0.05% and 5.0% (w/w) of the composition. A base such as sodium hydroxide is included in an amount to buffer the composition to the preferred pH (e.g., between about 4 and 5, preferably between 4.3 and 4.5., e.g., to 4.4.). The organic acid may be acetic acid present between about 0.25% and 5.0% (w/w) of the composition. The chlorine may be initially present between about 100 and 1,000 ppm.

The composition may include an excipient such as colloidal silica, synthetic clay materials, EDTA, polyethylene glycol, polysorbate, glycerol, acrylate copolymer, essential oils, buffers, cellulose derivatives, and xanthan gum.

In most preferred embodiments, the composition is produced, distributed, and stored for a period that can extend past six months for substantially all of which the composition is kept beneath about 25 degrees C. (preferably beneath 10 degrees, e.g., at about 6 degrees C.) and not exposed to air. Due to Henry's law, the composition does not include dissolved gases in proportions to the partial pressure of those gases in air. The composition preferably substantially does not include any gases such as oxygen, carbon dioxide, or nitrogen (although nitrogen may be permissible in embodiments in which nitrogen is used to occlude air from headspace in production containers). An insight of the invention is that, when keeping the temperature in the defined limits when coupled with control of the pH to the defined limits, chlorate does not substantially develop in the composition. In fact, compositions made in such manner have chlorate present as less than 5.4% of active chlorine species for up to six months.

Aspects of the invention provide uses of sodium hypochlorite in the manufacture of a biocidal product according to any of the embodiments herein.

In the invention provides hypochlorite-based biocidal compositions in which chlorate is present at ≤5.4% of the concentration of active chlorine species for up to 6 months from production.

The invention provides methods of disinfecting materials, in which methods comprise contacting material suspected to be carrying an infectious agent with a composition that inactivate the infectious agent, in which the composition include an aqueous solvent having therein an organic acid and chlorine in the solvent, and in which composition chlorate is maintained below a threshold percentage of active species of the chlorine. The composition includes a species of chlorine that inactivates the infectious agent. The infection agent may be a bacterium, a viral particle, or a prion. The chlorine may be present as hypochlorous acid. In fact, the method may indiscriminately inactive any bacteria, viruses, or prions that are present. The method may be used to treat material such as a surface to disinfect the surface or prophylactically, to inactivate any infectious agents that may come into contact the material. The method may be used to treat any suitable surfaces including, for example, countertops, subway and train handrails and straps, elevator buttons, household and office fixtures, etc. The method may be used to treat human parts, such as a hand sanitizer (e.g., in a dispensing bottle or wipes). The method may be used to treat animal parts (e.g., cow teats or hides, dog or horse ears, or other areas prone to infections). The method may include spraying materials suspected of carrying infectious agents using a spray bottle such as a trigger-capped spray bottle carrying the composition therein. Preferably the composition has been produced, distributed, and stored substantially without exposure to air and the composition does contain dissolved gases in proportion the partial pressures of those gases in air. The composition may be substantially free of dissolved oxygen or nitrogen. The method makes use of a compositions in which chlorate remains below the threshold percentage for at least six months after the composition is produced. For example in some embodiments, the method includes keeping the composition cold until contacting the material. Preferably the composition is held at, and has been since being produced held at, a temperature at or beneath about 25 degrees C. E.g., the method may include retrieving a spray bottle from a freezer or cold storage (refrigerator) and spraying the surface.

In the composition used in the method, the organic acid may be acetic acid. The composition may include a base that, with the organic acid, buffers the composition to a pH within a range between about 4 and 5. In certain embodiments, the organic acid is acetic acid, and the chlorine is introduced as sodium hypochlorite or hypochlorous acid, and the composition is kept beneath about 25 degrees and not exposed to air for substantially all time from production to use. These embodiments are good for inactivating prions as well as bacteria, viruses, and fungi. For example, the method includes exposing proteins of the infection agent to the sodium hypochlorite or hypochlorous acid to thereby denature the proteins rendering them incapable of further infectious activity. For buffering the composition, the compositions may include a strong base such as sodium hydroxide. In embodiments of the method, the compositions is buffered to a pH between about 4 and 5 and in various embodiment to about 4.4 or 4.7. Methods includer using compositions that have been produced, distributed, and stored for a period of months for substantially all of which period the composition is kept beneath about 25 degrees C. and not exposed to air. E.g., the period may be between zero and twelve months. With the buffering, the cold storage, and the exclusion of air, the composition retains its ability to inactivate the infectious agent(s) over the entire duration of the period (e.g., even up to 12 months). Methods of the invention use hypochlorite-based biocidal compositions in which chlorate is present at ≤4.5% of the concentration of active chlorine species for up to 6 months or longer from production to treat materials to inactivate any infectious agent (including microbes, viruses, or prions) that may be present on, or come in contact with, the materials.

### DETAILED DESCRIPTION

The invention provides compositions that include an aqueous solvent, an organic acid, and chlorine. The solvent may be water (e.g., tap water), de-ionized water, a saline solution, or other similar aqueous solvent. Any suitable organic acid may be used such as, for example, citric acid, glutamic acid, acetic acid, azelaic acid, benzilic acid, fumaric acid, gluconic acid, lactic acid, oleic acid, propiolic acid, rosolic acid, tannic acid, uric acid, gallic acid, formic acid, oxalic acid, malic acid, or tartaric acid, and more preferably one of lactic acid, acetic acid, formic acid, citric acid, oxalic acid, uric acid, malic acid, or tartaric acid. Chlorine may be provided as sodium hypochlorite or hypochlorous acid. Chlorine may be introduced as a salt such as sodium chloride and ionized by an electrical process, e.g., a process for making electrolyzed water.

Preferably the composition is made by buffering a 15% (w/w) aqueous solution of sodium hypochlorite with acetic acid and sodium hydroxide to within the range of pH 3.7 to pH 5.8, preferably to about pH 4.0 to 4.7, preferably pH 4.4.

By (i) ingredient choice, (ii) pH buffering, (iii) excluding excess oxygen or air, and (iv) control of temperature, compositions of the invention include active species of chlorine among which unwanted species of chlorine (e.g., chlorate and/or chlorine gas) are minimized.

Specifically, chlorate is preferably maintained below a threshold percentage of active species of the chlorine. Methods of the disclosure provide a composition in which chlorate is present well beneath 8 g/l when starting with a 15% (w/w) aqueous solution of sodium hypochlorite. Several compositions of the invention were sampled several times over multiple years and chlorate concentrations varied between 0.7 and 1.6 g/l including for more than six months after the compositions were made. Accordingly, the invention provides biocidal products comprising buffered solutions of hypochlorous acid in which chlorate is maintained below a threshold percentage of active species of the chlorine for over six months after making, in which the threshold percentage is 5.4%, i.e., of active chlorine, less than 5.4% is chlorate for six months or longer.

An object of compositions and methods of the disclosure is to maintain chlorate beneath a threshold % of chlorine-species present. Minimizing chlorate is preferably achieved through control of ingredients of the composition, pH of the composition, exposure to gases throughout production and storage (e.g., creation of “air-free” compositions by maintenance of air-free conditions during production and storage), and temperature control during production and storage. It particular, it may be preferable to keep ingredients and compositions of the invention in conditions with temperatures beneath a threshold temperature throughout production, transport, or storage. It may be preferable to keep the temperature beneath a threshold temperature of about 2 to 10 degrees C., preferably 6.

Ingredient choice minimizes chlorate.

In certain embodiments, HOCl or NaOCl is introduced into aqueous solvent at between about 100 and 600 ppm. Chlorine may be introduced by purchasing sodium hypochlorite and adding that as an ingredient. Sodium hypochlorite may be obtained commercially, e.g., as SKU #425044 under the trademark SIGMA-ALDRICH from Millipore Sigma, an affiliate of Merck KGaA (Darmstadt, DE) or from Kuehne Chemical Company, Inc. (South Kearny, NJ). In some embodiments, sodium hypochlorite (NaOCl) and salt (NaCl) are introduced initially, e.g., NaOCl dissolved at 171 g/L and NaCl dissolved at 125 g/L. In certain embodiments, the ingredient is sodium hypochlorite sold as “Natriumhypokloritt 15%” by Acinor AS (Norway), which is a 15% (w/w) solution of NaOCl.

Additionally or alternatively, chlorine may be introduced through the production of electrolyzed water. Electrolyzed water may be produced in an electrolysis chamber containing a dilute NaCl solution. The chamber includes a diaphragm (membrane or septum), which is used to separate the cathode and anode (Hricova, 2008, J Food Protect 71 (9): 1934-47, incorporated by reference). To produce electrolyzed water, current is passed through the generator, whereas voltage is generated between the electrodes. Suitable voltage and current values may be set at 9-10 V and 8-10 A. At onset of the electrolysis process, NaCl dissolves in water and dissociates into positively and negatively charged ions (Na+ and Cl−, respectively). Meanwhile, hydroxide (OH−) and hydrogen (H+) ions are also formed in the solution. The negatively charged ions (OH− and Cl−) move toward the anode where electrons are released and hypochlorous acid (HOCl), hypochlorite ion (—OCl), hydrochloric acid (HCl), oxygen gas (02), and chlorine gas (Cl2) may be generated. However, positively charged ions (Na+ and H+) move toward the cathode where they gain electrons, resulting in the generation of sodium hydroxide (NaOH) and hydrogen gas (H2). Two products are generated. At the anode, an acidic solution with a pH of 2 to 3, oxidation reduction potential (ORP)>1100 mV, and available chlorine concentration (ACC) of 10 to 90 ppm is produced. This solution is referred to as acidic electrolyzed water or electrolyzed oxidizing water. Meanwhile, at the cathode, a basic solution with a pH of 10 to 13 and ORP of −800 to −900 mV is produced and this solution is termed as basic electrolyzed water. Raman, 2016, Comp Rev Food Sci Food Safety 15:471, incorporated by reference.

As discussed in greater detail below, an organic acid and a base (e.g., acetic acid and sodium hydroxide) are included in amounts to buffer the pH of the composition to within the range of pH 3.7 to pH 5.8, preferably to about pH 4.0 to 4.7, preferably pH 4.4.

The composition may optionally include an excipient such as colloidal silica, synthetic clay materials, EDTA, polyethylene glycol, polysorbate, glycerol, acrylate copolymer, essential oils, buffers, cellulose derivatives, or xanthan gum.

Because the hypochlorous acid compositions of the invention are air-free, and thus stable, the air-free compositions have increased sterilizing properties. The air-free hypochlorous acid compositions of the invention are effective for breaking down biofilm infections and for treating wounds, among the other intended uses. Sodium hypochlorite may be obtained commercially, e.g., as SKU #425044 under the trademark SIGMA-ALDRICH from Millipore Sigma, an affiliate of Merck KGaA (Darmstadt, DE) or from Kuehne Chemical Company, Inc. (South Kearny, NJ).

Control of pH controls and minimizes chlorate.

The composition also preferably includes an organic acid. In one exemplary embodiment, the organic acid is acetic acid. The composition may also include a base. In preferred embodiments, the organic acid and the base buffer the composition to a preferred pH range. In the exemplary preferred embodiment, the organic acid is acetic acid and the included base is sodium hydroxide (NaOH). The acetic acid and sodium hydroxide are included in quantities that buffer the pH of the composition to within the range of pH 3.7 to pH 5.8. Preferably, the composition is buffered to about pH 4.0 to 4.7, preferably pH 4.4.

Chlorate is mainly formed from hypochlorite at pH-values>6,5 to pH<13 according to the reactions;

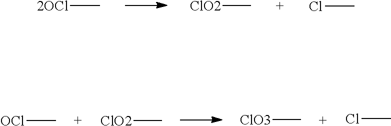

ClO2— is called a chlorine dioxide anion

The mechanism is often referred to as a Lister reactions and is acknowledged as the main formation pathway for chlorate in hypochlorite solutions. Lister, 1956, Decomposition of sodium hypochlorite, Canadian J Chem 34 (4): 465-478, incorporated by reference. In solutions of hypochlorous acid (at pH 4.3) only minute concentrations of excess chlorine dioxide anions can be expected (since chlorine dioxide anions are both formed and consumed by hypochlorite anions in the Lister sequence depicted above, and hypochlorite anions are really scarce at that pH-value).

Even if chlorine dioxide anions were present in high concentrations in compositions of the invention, those anions would not primarily react to form chlorate in any considerable amount since another reaction where chlorine dioxide is formed will be dominant.

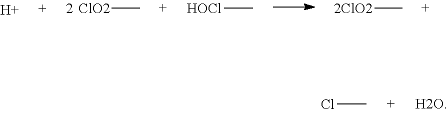

Accordingly, among other factors, control of pH significantly inhibits the development of chlorate.

Control of exposure to gases throughout production and storage (e.g., creation of “air-free” compositions by maintenance of air-free conditions during production and storage) minimized chlorate.

Compositions of the invention are preferably air-free and are made to be that way by making, transporting, and storing the compositions in air-free environments meaning that the ingredients of the compositions and the compositions themselves are not exposed to the ambient atmosphere of Earth for any substantial amount of time during production, mixing, transportation, and storage (where transportation includes transferring between containers, such as from a vat at a production facility into jerry cans for overland transport or from jerry cans into storage vats at final destinations such as commercial warehouses or clinical facilities). Due to those careful controls, compositions of the invention are air-free and have properties distinct from those compositions that contain or are exposed to air.

Hypochlorous acid compositions that are air-free are more stable and have significant disinfecting properties, making them effective at treating wounds and breaking down biofilm.

Hypochlorous acid (HOCl) is a weak acid that forms along with hydrochloric acid when chlorine gas (Cl₂) dissolves in water, resulting in the following reaction:

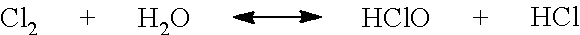 [SMILES: Cl ; "HClO" ; "Cl2" ; O]

Cl₂ may be considered to be a harmful gas and is preferably not substantially present in compositions of the invention.

The hypochlorous acid itself partially dissociates in aqueous solution, forming a hypochlorite ion, OCl⁻ resulting in the following reaction:

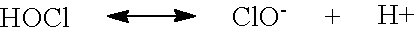

As such, in aqueous solution there is equilibrium between HOCl, OCl and other chlorine species. Molecular HOCl and OCl⁻ both represent species of free-chlorine available for use as a disinfectant. It has been found that air-free production disfavors chlorine gas.

The concentration of the free-available chlorine is dependent on maintaining the equilibrium. At equilibrium, the pH of the solution is between 4.5 and 7.0. It is the pH of the solution that determines the equilibrium, and thus the stability of the hypochlorous acid solution.

Air destabilizes hypochlorous acid. When a hypochlorous acid solution is exposed to air, the pH of the solution increases. An increase in pH causes the equilibrium of the solution to shift to the right. This shift decreases the concentration of the more potent free-available chlorine of HOCl, increases the concentration of the less effective hypochlorite ion, and releases toxic chlorine gases, like Cl₂. Thus, avoiding exposure to air minimizes chlorine gas.

Air-free production of hypochlorous acid is beneficial for maintaining the desired equilibrium of compositions of the invention. Producing compositions of the invention in an air-free environment inhibits the production of chlorine gases.

The Earth's air is made of approximately 78.09% nitrogen, 20.95% oxygen, 0.93% argon, and 0.04% carbon dioxide, and not just carbon dioxide. The present invention is substantially free of components of atmospheric air.

Control of temperature during production, transportation, and storage of compositions of the invention minimizes chlorate.

Compositions of the invention may be made, transported, and stored (e.g., temporarily stored at distribution facilities during transportation and finally stored in a destination facility) in a supply chain that spans multiple locations and multiple months and in which temperatures are maintained substantially beneath a threshold temperature, e.g., substantially maintained beneath about 10 degrees C. Substantially maintained can be taken to mean that for about 90% of the duration of the supply chain, the temperature was beneath the threshold. For example, if the duration of the supply chain is 150 days, then for no cumulative period of at least 15 days did the temperature meet exceed the threshold temperature. About may be taken to mean without about 10 to 30 percent of a given value, e.g., about 10 may be taken to mean between about 9 and 11 or between about 7 and 13. In some embodiments, a supply chain of a method and composition of the invention is less than about 200 days for which period the temperatures of all ingredients and compositions is substantially maintained at less than about 10 degrees C.

In most preferred embodiments, a supply chain includes (i) production of the initial ingredients, (ii) transfer into a cold storage container, (iii) storage at the production facility, (iv) transport to a distributor facility, (v) cold storage at the distributor facility, (vi) transfer into packaging cannisters, (vii) cold storage, (viii) transport to destination facility, and (ix) storage at the destination facility.

Results of control of ingredient choice, pH buffering, excluding excess oxygen or air, and control of temperature are shown by measuring chlorate in compositions of the invention.

Products were made, transported, and stored according to methods of the disclosure. A 15% (w/w) solution of NaOCl was purchased commercially and used an ingredient. The ingredients and the products were tested for tested for chlorate concentration. Table 1 gives the results of testing for chlorate concentration in ingredients and products.

TABLE 1

| | | | | Storage | |
|---|---|---|---|---|---|
| | | Ingre- | | condi- | |
| Ref | Production | dient | | tions | Chlorate |
| Code | date | (ppm) | Test date | (° C.) | (mg/L) |
| S450a | Feb. 11, 2021 | 451 | Feb. 11, 2021 | 25 | 66.2 |
| S200a | Feb. 11, 2021 | 200 | Feb. 11, 2021 | 25 | 28.6 |
| S200b | Mar. 18, 2020 | 219 | Feb. 11, 2021 | 25 | 38.0 |
| S450b | Jul. 4, 2019 | 449 | Feb. 11, 2021 | 25 | 143 |
| Batch | Ingredient | — | — | 6 | 15300 |
| ′94 | | | | | |
| Batch | Ingredient | — | — | 6 | 13800 |
| ′73 | | | | | |

The results in Table 1 show that for the products made at least 10 months before the test date and stored at 25 degrees C., the chlorate concentrations were at 143 mg/L or lower.

One target threshold was to have the chlorate be less or equal to 5.4% of active chlorine, which would be 0.81% (w/w) of chlorate, or 8.1 g/L. The highest measured chlorate concentration in the measured products 143 mg/L, well beneath the target 8000 mg/L. The 5.4% is one critical threshold due to certain regulatory frameworks and targets for bringing safe products to a consumer market. For example, according to “Recommended requirements for the active substances active chlorine released from sodium hypochlorite, hydrogen peroxide and paracetic acid”, Apr. 7, 2020, from the European Chemicals Agency (3 pages), the permissible limit on sodium chlorate released from sodium hypochlorite is ≤5.4% of available chlorine. See also Regulation (EU) No 528/2012 concerning the making available on the market and use of biocidal products, Evaluation of active substances Assessment Report Active chlorine released from sodium hypochlorite, January 2017 (112 pages), incorporated by reference.

Sodium hypochlorite aqueous solutions release ‘active chlorine’, i.e. efficacious chlorine or available/releasable chlorine that is disinfectant, algaecide, fungicide and microbiocide. Namely, in water sodium hypochlorite (NaClO) hydrolyzes to hypochlorous acid (HClO) according to:

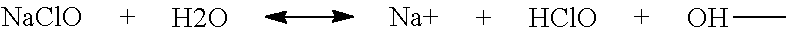

Furthermore, hypochlorous acid participates in the following equilibrium with chlorine (Cl2):

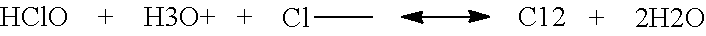

The ratio of Cl2/HClO/ClO— is pH and temperature dependent. The percentage of the different species at the equilibrium is substantially a function of pH, temperature, ingredients, and time. Hypochlorous acid is predominant in the pH range 4 to 5.5, whereas the hypochlorite anion predominates at pH>10. Chlorine is present at pH<4 absent other controls or considerations.

Compositions of the disclosure further include an organic acid, preferably buffered, e.g., by a strong base. Compositions of the disclosure are buffered to a specific pH range of about pH 3.7 to about pH 5.8. Preferably, the composition is buffered to about pH 4.0 to 4.7, preferably pH 4.4. Compositions of the disclosure are made, transported, and stored under substantially air-free conditions and substantially beneath 25 degrees C., preferably beneath about 10 degrees C. In compositions of the invention, active species of chlorine are predominantly present as hypochlorous acid and the percent of the active species of chlorine that is present as chlorate is kept beneath a threshold, preferably 5.4%, for at least six months after production. For compositions of the invention, simulations and tests have indicated that chlorate (ClO3—) is formed to a concentration of 6.91 g/l over 143 days after production when the product was kept at 6° C. for that duration even if there were a cumulative 24 hours of spikes to 15° C., which conditions are deemed to be substantially beneath about 10 degrees C., preferably about 6 degree C., for at least six months. Note that 6.91 g/l concentration of chlorate represents about 4.4% of chlorate of the active chlorine.

The amount of chlorate was estimated by simulation using a simulation software program named ‘Bleach 2001’. See Adam, 2001, Bleach 2001, software program published by AwwaRF and AWWA, Denver, described in Stanford, 2011, Perchlorate, Bromate, and Chlorate in Hypochlorite Solutions: Guidelines for Utilities, J Am Water Works Assoc 103 (6): 71-83, incorporated by reference. To compare the predictions from the simulation software program, samples of the raw ingredient sodium hypochlorite 15% were purchased and immediately put into cold storage below 6 degrees C. After three weeks, those samples tested as having 2 g/l chlorate. Another sample measured at 60 days of cold storage had 3.44 g/l chlorate. Those measured values are lower than what was predicted by the simulation software program. Thus, simulations may give a modestly “worse case” than real-world values.

A product of the invention was made with 200 ppm hypochlorous acid and analyzed (Ref s200b). When freshly prepared, the product had a 28.6 ppm chlorate concentration. After about 11 months of cold storage at 25 degrees C., the product had a hypochlorous acid concentration of 176 ppm and chlorate concentration of 38 ppm (see table 1).

Similarly, data from the analysis of a freshly prepared 450 ppm product having a hypochlorous acid concentration of 451 ppm had a chlorate concentration 66.2 ppm when freshly prepared (Ref s250b). The product after about 20 months of cold storage at 25 degrees C. was analyzed and found to have a post storage hypochlorous acid concentration of 284 ppm and a chlorate concentration of 143 ppm (see table 1).

Compositions of the disclosure may be provided as disinfectant sprays, e.g., in spray-trigger bottles, or in refill bottles. Compositions of the disclosure inactivate microbes including both bacteria and eukaryotes (yeast and fungi). Further, compositions inactivate spores and are thus useful to treat biofilms. Compositions of the disclosure are useful to inactivate prions.

### INCORPORATION BY REFERENCE

References and citations to other documents, such as patents, patent applications, patent publications, journals, books, papers, web contents, that have been made throughout this disclosure are hereby incorporated herein by reference in their entirety for all purposes.

### EQUIVALENTS

The invention may be embodied in other specific forms without departing from the spirit or essential characteristics thereof. The foregoing embodiments are therefore to be considered in all respects illustrative rather than limiting on the invention described herein.

### Examples

### Chlorate Data:

A company has measured the chlorate concentration in a 450 ppm product (batch s/077) after 12+ months of stability storage and after 24+ months of continuous storage at 25 degrees C.

The sample had a hypochlorous acid concentration of 443 ppm as freshly prepared 2018 Dec. 11 (T=0 months). After 12 (+)-month of storage (2020 Feb. 2), an independent research organization measured the chlorate concentration to 77 ppm.

On 2020 Mar. 26 the hypochlorous acid concentration of the product samples was measured to be 258 ppm and as of 2021 Mar. 10 the hypochlorous acid concentration was 172 ppm and the corresponding chlorate concentration (determined by the independent research organization on 2021 Mar. 11) as 81 ppm.

The result verifies that, albeit expected degradation of hypochlorous acid over the 24 months of stability storage testing (HOCl at T=0 months; 443 ppm, HOCl at T=24 months; 172 ppm), the formation of chlorate during the period T=12 months to T=24 months is negligible (an increase of from 77 ppm to 81 ppm).

The sample provides information on a worst-worst case of chlorate formation as measured at T=12 months and at T=24 months, with the corresponding hypochlorous acid determinations.

In furtherance to this particular result, two more product samples were subject to determination of hypochlorous acid as well as determination of chlorate in a sequence of extended storage stability tests. The 200 ppm Product of batch S/79 (HOCl=167 ppm at T=0) had its chlorate concentration determined as 18 ppm after 14 months of storage stability testing at 25 degrees C., and again after 27 months of continuous storage stability testing at 25 degrees C., as 20 ppm chlorate. Thus, net increase by only 2 ppm of chlorate albeit the fact that the concentration of active chlorine (measured as HOCl) decreased from 167 ppm (at T=0 m to 107 ppm (at T=27 months).

Yet the last product sample represents a 200 ppm-product subjected to a 22-months storage stability testing at 5 degree C., resulting in a chlorate concentration of 32 ppm. Extending the storage stability testing of this particular product sample to 35 months (at 5 degree C.) does in fact not result in any further chlorate formation (chlorate concentration at T=35 months; 31 ppm).

The results of those storage stability tests in which chlorate has in fact been measured in extended sequences is summarized in Table 2.

TABLE 2

| Product | Batch | Production | HOCl (ppm) | Chlorate (ppm) | |
|---|---|---|---|---|---|
| ppm | no. | date | (date) | (date) | Comment |
| 450 | S/077 | 2018 Dec. 11 | 443 (2018 Dec. 11) | N/A | Fresh |
| 450 | S/077 | N/A | N/A | 77 (2020 Feb. 2) | T = 12 mo |
| 450 | S/077 | N/A | 258 (2020 Mar. 26) | N/A | |
| 450 | S/077 | N/A | 172 (2021 Mar. 10) | 81 (2021 Mar. 11) | T = 24 mo |
| 200 | S/79 | 2018 Dec. 12 | 167 (2018 Dec. 12) | | fresh |
| 200 | S/79 | N/A | N/A | 18 (2020 Feb. 2) | T = 14 mo |
| 200 | S/79 | 2018 Dec. 12 | 107 (2021 Mar. 10) | 20 (2021 Mar. 11) | T = 27 mo |
| 200 | S/31 | 2018 May 1 | 210 (2018 May 1) | N/A | fresh |
| 200 | S/31 | 2018 May 1 | N/A | 32 (2020 Feb. 2) | T = 22 mo/at |
| | | | | | 5° C. |
| 200 | S/31 | 2018 May 1 | 181 (Oct. 3, 2021) | N/A | |
| 200 | S/31 | 2018 May 1 | N/A | 31 (2021 Mar. 11) | T = 35 mo, at |
| | | | | | 5° C. |

Further storage stability testing was performed, in which a company measured chlorate concentration in a 200 ppm product (batch SOF004/077) over a 12 month period of continuous storage at 25 degree C.

The sample had a hypochlorous acid concentration of 213 ppm as freshly prepared (T=0 months). The hypochlorous acid concentration and chlorate concentration was measured from the initial date of preparation (T=0 months), as well as at incremental dates, including after 1.03 months, 2.57 months, 6.17 months, 9.2 months, and at 12 months.

The results of this storage stability testing in which chlorate has in fact been measured in extended sequences is summarized in Table 3.

TABLE 3

| Product | | Time | | HOCl | | Storage conditions |
|---|---|---|---|---|---|---|
| ppm | Batch no. | (months) | | (ppm) | Chlorate | (° C.) |
| 200 | SOF004/077 | 0 | months | 213 | 4.6 | Fresh, with pH of 4.5 |
| 200 | SOF004/077 | 1.03 | months | 204 | 4.77 | 25 |
| 200 | SOF004/077 | 2.57 | months | 196 | 6.15 | 25 |
| 200 | SOF004/077 | 6.17 | months | 175 | 7.44 | 25 (pH of 4.5) |
| 200 | SOF004/077 | 9.2 | months | 161 | 7.27 | 25 (pH of 4.5) |
| 200 | SOF004/077 | 12 | months | N/A | 8.76 | 25 |

Data indicates that the long-term stability of biocidal products are not in doubt by any means, as extensive long term stability testing shows the stability of the active chlorine (e.g. hypochlorous acid). Hypochlorous acid in the products show some degradation as a function of storage time, as can be expected, but results are consistent—the degradation of hypochlorous acid in the products are not correlated with any formation of chlorate. Rather, the chlorate concentrations in the products resides from the fact that the raw material, degrades to chlorate upon extended storage.

1-22. (canceled)

23. A method for storing a biocidal composition, the method comprising:
a) providing a composition comprising:
an aqueous solvent;
an organic acid in the solvent; and
chlorine in the solvent;
b) storing the composition substantially without exposure to air; and
c) maintaining chlorate below a threshold of 5.4% of active species of the chlorine.

24. The method of claim 23, comprising maintaining chlorate below the threshold percentage for at least six months from the time the composition is provided.

25. The method of claim 24, comprising keeping the temperature of the composition at or beneath about 25 degrees C. during storage.

26. The method of claim 24, comprising keeping the temperature of the composition beneath a threshold temperature of 10 degrees C. during storage.

27. The method of claim 23, wherein the organic acid is acetic acid.

28. The method of claim 23, wherein the active species of chlorine are predominantly present as hypochlorous acid.

29. The method of claim 23, comprising buffering the composition to a pH of about 4.7-5.8.

30. The method of claim 23, wherein the chlorine is provided as one selected from the group consisting of sodium hypochlorite (NaOCl), magnesium hypochlorite (Mg(OCl)₂), and calcium hypochlorite (Ca(OCl)₂).

31. The method of claim 23, wherein the organic acid is present between about 0.05% and 5.0% (w/w) of the composition.

32. The method of claim 23, wherein the organic acid is acetic acid present between about 0.25% and 5.0% (w/w) of the composition.

33. The method of claim 23, wherein the chlorine is present between about 100 and 1,000 ppm.

34. The method of claim 23, wherein the composition further comprises an excipient.

35. The method of claim 23, comprising storing the composition for at least six months for substantially all of which the composition is kept beneath about 10 degrees C.

36. The method of claim 23, comprising maintaining chlorate at no more than 5.4% of the concentration of active chlorine species for up to six months from the time the composition is provided.
